(19) United States
(12) Patent Application Publication
(10) Pub. No.: US 2017/0175952 A1
(43) Pub. Date: Jun. 22, 2017

(54) LIQUEFIED NATURAL GAS STORAGE TANK AND INSULATING WALL FOR LIQUEFIED NATURAL GAS STORAGE TANK

(71) Applicant: DAEWOO SHIPBUILDING & MARINE ENGINEERING CO., LTD., Seoul (KR)

(72) Inventor: Haeng Sung HEO, Seoul (KR)

(73) Assignee: DAEWOO SHIPBUILDING & MARINE ENGINEERING CO., LTD., Seoul (KR)

(21) Appl. No.: 15/323,947

(22) PCT Filed: Jul. 2, 2015
(86) PCT No.: PCT/KR2015/006813

§ 371 Date: Jan. 4, 2017

(30) Foreign Application Priority Data
Jul. 4, 2014 (KR) 10-2014-0083670
Jul. 15, 2014 (KR) 10-2014-0089311

(51) Int. Cl. F17C 3/02; F17C 3/04

(52) U.S. Cl. CPC F17C 3/025; F17C 3/04; F17C 3/027; F17C 2221/033; F17C 2270/0107

(57) ABSTRACT

The present invention relates to a liquefied natural gas (LNG) storage tank having slits in the upper and lower portions of a first insulating wall, and to an insulating wall for an LNG storage tank. One embodiment of the present invention provides a storage tank for storing LNG therein, comprising: a first sealing wall coming into contact with the LNG stored in the storage tank, for liquid-tight sealing the LNG; and a first insulating wall disposed below the first sealing wall, for insulating the LNG, wherein the first insulating wall has a plurality of first slits in the upper portion thereof and a plurality of second slits in the lower portion thereof.

### TECHNICAL FIELD

The present invention relates to an LNG storage tank, and, more particularly, to a membrane-type storage tank having a double heat insulating wall structure.

### BACKGROUND ART

Natural gas is a fossil fuel containing methane as a main component and a small amount of ethane and propane and has attracted attention as a low-pollution energy source in various technical fields.

Generally, natural gas is transported through an onshore or offshore gas pipe line in a gaseous state, or to remote sources of demand by an LNG carrier in the form of liquefied natural gas (hereinafter, ‘LNG’). LNG is obtained by cooling natural gas to an extremely low temperature (about −163° C.) and is suitable for long-distance transportation by sea since LNG has a volume of about 1/600 that of natural gas in a gaseous state.

An LNG carrier is equipped with a storage tank (also referred to as ‘cargo tank’) that can store and retain LNG obtained by cooling and liquefying natural gas. Since the boiling point of LNG is about −162° C. at atmospheric pressure, an LNG storage tank may be formed of materials that can withstand ultra-low temperatures, such as aluminum, stainless steel and 35% nickel steel, to safely store and retain LNG and is designed to be resistant to thermal stress and thermal shrinkage and to prevent heat intrusion.

In addition to LNG carriers, LNG RVs (regasification vessels) carrying LNG to an onshore source of demand, regasifying LNG into natural gas, and unloading the natural gas are provided with an LNG storage tank. Recently, floating marine structures such as LNG FPSO (Floating, Production, Storage and Unloading) and LNG FSRU (Floating Storage and Regasification Unit) also include storage tanks installed on LNG carriers or LNG RVs.

An LNG FPSO is a floating marine structure that is used to liquefy produced natural gas at sea and store the liquefied natural gas in a storage tank and to offload the LNG onto an LNG carrier, if necessary. An LNG FSRU is a floating marine structure that is used to store LNG unloaded from an LNG carrier at sea in a storage tank and to regasify the LNG and supply the regasified LNG to onshore sources of demand, if necessary.

As such, offshore structures for transporting or storing liquid cargo such as LNG, such as LNG carriers, LNG RVs, LNG FPSOs, and LNG FSRUs, are provided with a storage tank for storing LNG under cryogenic conditions.

Such a storage tank is divided into an independent-type and a membrane-type depending upon whether the weight of cargo is directly applied to a thermal insulation material. Typically, the membrane-type storage tank is divided into a GTT NO 96-type and a TGZ Mark III-type, and the independent-type storage tank is divided into a MOSS-type and an IHI-SPB-type.

FIG. 1 is a schematic view of a GTT NO 96-type storage tank, which is a conventional LNG storage tank.

Referring to FIG. 1, the GTT NO 96-type storage tank has a structure in which a primary sealing wall 130, a primary heat insulating wall 110, a secondary sealing wall 140, and a secondary heat insulating wall 120 are sequentially stacked. Each of the primary sealing wall 130 and the secondary sealing wall 140 is formed of Invar steel (36% Ni) having a thickness of 0.5 mm to 1.5 mm, and the primary sealing wall and the secondary sealing wall have almost the same liquid tightness and strength. Thus, even when the primary sealing wall leaks, the secondary sealing wall can safely retain a cargo for a considerable period of time. In addition, since a membrane of the sealing wall of the GTT NO 96-type storage tank is linear, the membrane is easier to weld and has a higher rate of automation than a corrugated membrane of a TGZ Mark III-type storage tank, but the overall weld length thereof is longer than that of the membrane of the TGZ Mark III-type storage tank.

The primary heat insulating wall 110 and the secondary heat insulating wall 120 are formed of a plywood box and perlite, and an inner space of each of the heat insulating walls where vertical members 150 formed of plywood are arranged is filled with perlite and nitrogen gas.

FIG. 2 is a schematic view of a TGZ Mark III-type storage tank, which is a conventional LNG storage tank.

Referring to FIG. 2, the TGZ Mark III-type storage tank has a structure in which a primary sealing wall 230, a primary heat insulating wall 210, a secondary sealing wall 240, and a secondary heat insulating wall 220 are stacked. The primary sealing wall 230 is in direct contact with LNG stored in the storage tank and is formed of a stainless steel membrane having a thickness of 1.2 mm, and the secondary sealing wall 240 is formed of triplex.

The primary heat insulating wall 210 and the secondary heat insulating wall 220 are formed of polyurethane foam or the like. Here, the primary heat insulating wall 210, the secondary sealing wall 240 and the secondary heat insulating wall 220 are glued together to secure the primary heat insulating wall 210 to the secondary heat insulating wall 220.

There is a large difference between the temperature of the primary heat insulating wall 210 upon initial installation and the temperature of the primary heat insulating wall when LNG is stored in the LNG storage tank. Thus, the primary heat insulating wall receives stress due to thermal contraction when the liquefied natural gas is stored in the storage tank. Slits are formed in the primary heat insulating wall 210 to reduce such stress. FIG. 3 is a view showing thermal contraction-induced behavior of a primary heat insulating wall of a typical LPG storage tank.

For the typical LPG storage tank, slits are formed in an upper plate of the primary heat insulating wall 210. Thus, the primary heat insulating wall 210 is deformed as shown in FIG. 3 when undergoing thermal contraction. At the upper side of FIG. 9, there is shown a primary heat insulating wall 420 which is placed at room temperature and is not deformed, and, at the lower side of FIG. 9, there is shown a primary heat insulating wall 420 which is bent upward due to temperature deviation (t) in the thickness direction during carriage of LNG under cryogenic conditions, causing a step (d).

Such a step (d) can be a structural risk factor of the LNG storage tank when sloshing occurs during the carriage of LNG.

In addition, in the typical LPG storage tank, since the secondary sealing wall is formed of triplex, there is a problem in that the secondary sealing wall may leak.

### DISCLOSURE

### Technical Problem

It is an aspect of the present invention to provide an LNG storage tank which is structurally stable against thermal contraction of a primary heat insulating wall, can reduce the probability that a secondary sealing wall leaks, thereby securing safety, and can reduce processing costs.

### Technical Solution

In accordance with one aspect of the present invention, there is provided a liquefied natural gas storage tank including: a primary sealing wall contacting liquefied natural gas stored in the storage tank and sealing the storage tank in a liquid-tight manner; and a primary heat insulating wall placed under the primary sealing wall and thermally insulating the storage tank, wherein the primary heat insulating wall has a plurality of first slits formed at an upper portion thereof and a plurality of second slits formed at a lower portion thereof.

Particularly, the plurality of first slits may be formed at points where the primary heat insulating wall meets corrugated portions of the primary sealing wall.

The primary heat insulating wall may include: an upper plate adjoining the primary sealing wall; a lower plate; and an insulator interposed between the upper plate and the lower plate, wherein the plurality of first slits may be formed in the upper plate of the primary heat insulating wall at constant intervals, and the plurality of second slits may be formed in the lower plate of the primary heat insulating wall at constant intervals.

Each of the plural first slits may extend from the uppermost portion of the upper plate to a portion of the insulator.

Each of the plural second slits may extend from the lowermost portion of the lower plate to a portion of the insulator.

The plurality of first slits may be formed in a grid pattern.

The liquefied natural gas storage tank may further include: a secondary heat insulating wall disposed on an inner wall of the storage tank and thermally insulating the storage tank; and a heat insulating wall securing element securing the primary heat insulating wall to the secondary heat insulating wall such that the primary heat insulating wall can slide in a horizontal direction.

The heat insulating wall securing element may include a stud bolt secured to the secondary heat insulating wall and a nut fastened to the stud bolt; the primary heat insulating wall is formed with a through-hole; and the stud bolt is inserted into the through-hole and fastened to the nut, such that the primary heat insulating wall is secured to the secondary heat insulating wall.

The liquefied natural gas storage tank may further include a secondary sealing wall.

The primary sealing wall and the secondary sealing wall may be formed of stainless steel.

In accordance with another aspect of the present invention, there is provided a heat insulating wall for a liquefied natural gas storage tank, including: an upper plate adjoining a sealing wall; a lower plate; and an insulator interposed between the upper plate and the lower plate, wherein the upper plate has a plurality of first slits formed at constant intervals and the lower plate has a plurality of second slits formed at constant intervals.

The plurality of first slits may be formed at points where the primary heat insulating wall meets corrugated portions of the primary sealing wall.

Each of the plurality of first slits may be formed from the uppermost portion of the upper plate to a portion of the insulator.

Each of the plurality of second slits may be formed from the lowermost portion of the lower plate to a portion of the insulator.

The plurality of first slits may be formed in a grid pattern.

In accordance with a further aspect of the present invention, there is provided a liquefied natural gas storage tank including: a primary sealing wall contacting liquefied natural gas stored in the storage tank and sealing the storage tank in a liquid-tight manner; a primary heat insulating wall disposed under the primary sealing wall and thermally insulating the storage tank; a secondary heat insulating wall disposed on an inner wall of the storage tank and thermally insulating the storage tank; and a secondary sealing wall interposed between the primary heat insulating wall and the secondary heat insulating wall to seal the storage tank in a liquid-tight manner when the primary sealing wall leaks, wherein the secondary heat insulating wall includes a plurality of secondary heat insulating wall panels, each of the secondary heat insulating wall panels has a groove formed at an upper portion thereof, the secondary sealing wall is formed with a corrugated portion, and the secondary sealing wall is placed on the secondary heat insulating wall such that the corrugated portion is located in a gap between the plurality of secondary heat insulating wall panels and in the groove.

The secondary heat insulating wall may include an upper plate adjoining the secondary sealing wall; a lower plate; and an insulator interposed between the upper plate and the lower plate, and the groove may be formed from the uppermost portion of the upper plate to a portion of the insulator.

The primary sealing wall and the secondary sealing wall may be formed of stainless steel.

The secondary heat insulating wall may be provided on an upper portion thereof with a first metal strip, and the secondary sealing wall may be welded to the first strip.

The liquefied natural gas storage tank may further include a heat insulating wall securing element securing the primary heat insulating wall to the secondary heat insulating wall such that the primary heat insulating wall can slide in a horizontal direction.

The heat insulating wall securing element may include a stud bolt secured to the secondary heat insulating wall and a nut fastened to the stud bolt; the primary heat insulating wall may be formed with a through-hole; and the stud bolt may be inserted into the through-hole and fastened to the nut, such that the primary heat insulating wall is secured to the secondary heat insulating wall.

The upper plate of the secondary heat insulating wall may be provided with a second metal strip, and the stud bolt may be secured to the second strip.

The liquefied natural gas storage tank may further include a plug plugging a hole for installing the heat insulating wall securing element.

In accordance with yet another aspect of the present invention, there is provided a heat insulating wall for a liquefied natural gas storage tank, including: an upper plate adjoining a sealing wall; a lower plate; and an insulator interposed between the upper plate and the lower plate, wherein the heat insulating wall includes a plurality of heat insulating wall panels, each of the plurality of heat insulating wall panels has a groove formed at an upper portion thereof, the sealing wall is formed with a corrugated portion, and the sealing wall is placed on the heat insulating wall such that the corrugated portion is located in a gap between the plurality of heat insulating wall panels and in the groove.

Particularly, the groove may extend from the uppermost portion of the upper plate to a portion of the insulator.

The sealing wall may be formed of stainless steel.

The heat insulating wall may be provided on an upper portion thereof with a first metal strip and the sealing wall may be welded to the first strip.

### Advantageous Effects

According to embodiments of the present invention, a plurality of slits is formed in upper and lower portions of a primary heat insulating wall, whereby it is possible to prevent the primary heat insulating wall from being bent upward when the primary heat insulating wall undergoes thermal contraction, thereby reducing stress of the primary heat insulating wall 420. As a result, stress generated in a heat insulating wall securing element is lowered, such that the storage tank can be structurally stable.

In addition, according to embodiments of the present invention, a secondary sealing wall is formed of stainless steel, thereby reducing the possibility that the secondary sealing wall leaks, and a secondary heat insulating wall has a groove such that a corrugated portion of the secondary sealing wall is located in the groove, thereby securing safety while reducing processing costs.

### DESCRIPTION OF DRAWINGS

FIG. 1 is a schematic view of a GTT NO 96-type storage tank, which is a conventional LNG storage tank.

FIG. 2 is a schematic view of a TGZ Mark III-type storage tank, which is a conventional LNG storage tank.

FIG. 3 is a view showing thermal contraction-induced behavior of a primary heat insulating wall of a typical LPG storage tank.

FIG. 4 is a sectional view of an exemplary ship having an LNG storage tank according to an embodiment of the present invention.

FIG. 5 is a sectional view of a heat insulating structure of an LNG storage tank according to an embodiment of the present invention.

FIG. 6 is a perspective view of the heat insulating structure of the LNG storage tank according to the embodiment of the present invention.

FIG. 7 is a view illustrating a structure of a heat insulating wall securing element of an LNG storage tank according to an embodiment of the present invention.

FIG. 8 is a view illustrating a method of installing a plug of the heat insulating wall securing element of the LNG storage tank according to the embodiment of the present invention.

FIG. 9 is a sectional view of a primary heat insulating wall of an LNG storage tank according to an embodiment of the present invention.

FIG. 10 is a view showing the location where a primary sealing wall of an LNG storage tank according to an embodiment of the present invention meets upper slits of a primary heat insulating wall of the LNG storage tank.

FIG. 11 is a view showing thermal contraction-induced behavior of the primary heat insulating wall of the LNG storage tank according to the embodiment of the present invention.

FIG. 12 is a view of a secondary heat insulating wall panel according to an embodiment of the present invention.

FIG. 13 is a view of a secondary sealing wall unit according to an embodiment of the present invention.

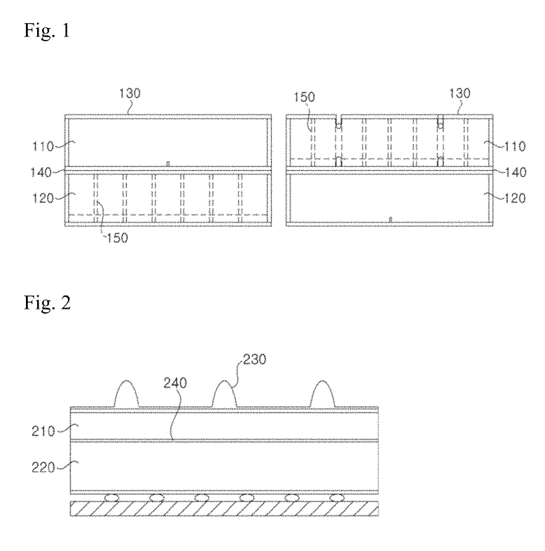

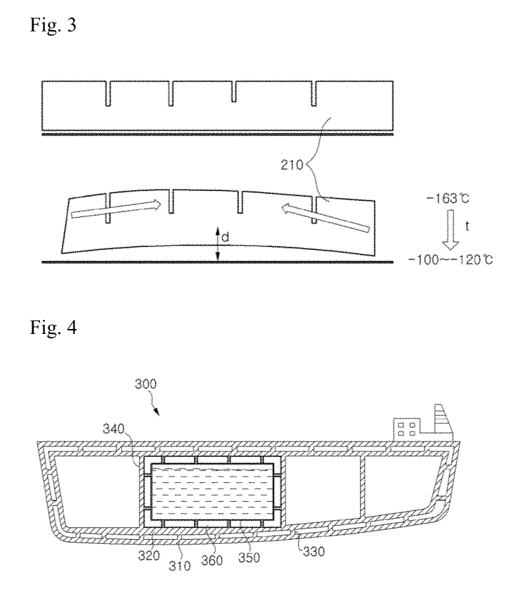

### EMBODIMENTS

Hereinafter, embodiments of the present invention will be described with reference to the accompanying drawings. It should be noted that like components will be denoted by like reference numerals throughout the specification and the accompanying drawings. In addition, descriptions of details apparent to those skilled in the art will be omitted for clarity.

First, a structure of a ship having an LNG storage tank according to an embodiment of the present invention will be described with reference to FIG. 4. FIG. 4 is a sectional view of an exemplary ship having an LNG storage tank according to an embodiment of the present invention.

Referring to FIG. 4, the LNG storage tank according to the embodiment of the present invention may be installed in a ship 300, and the ship 300 is composed of a hull having a double structure of an outer wall 310 forming an outer shape and an inner wall 320 formed inside the outer wall 310. The inner wall 320 and the outer wall 310 of the ship 300 may be connected to each other through a connecting rib 330 to be integrally formed with each other. Alternatively, the ship 300 may be composed of a hull having a single structure without the inner wall 320. In addition, only an upper portion of the ship 300 may be formed as a single deck, and the outer shape of the deck may vary depending on the size or storage capacity of the ship 300.

Further, the interior of the inner wall 320 may be divided by one or more bulkheads 340, and the bulkhead 340 may also form a cofferdam.

A sealing wall 350 seals the storage tank containing LNG in a liquid-tight manner, is in contact with the LNG, and may have a corrugated portion to cope with temperature change caused by loading/unloading of ultra-low temperature LNG.

A heat insulating wall 360 is formed between the sealing wall 350 and the inner wall 320 to thermally insulate the storage tank. The heat insulating wall 360 is composed of a primary heat insulating wall and a secondary heat insulating wall, and the sealing wall may be interposed between the primary heat insulating wall and the secondary heat insulating wall.

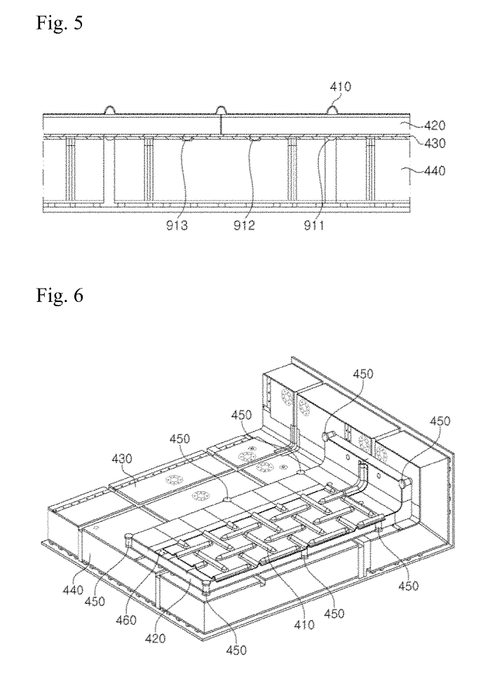

Next, a heat insulating structure of an LNG storage tank according to an embodiment of the present invention will be described with reference to FIGS. 5 and 6. FIG. 5 is a sectional view of a heat insulating structure of an LNG storage tank according to an embodiment of the present invention and FIG. 6 is a perspective view of the heat insulating structure of the LNG storage tank according to the embodiment of the present invention.

Referring to FIGS. 5 and 6, the LNG storage tank according to the embodiment of the present invention includes a primary sealing wall 410, a primary heat insulating wall 420, a secondary sealing wall 430, a secondary heat insulating wall 440, and a heat insulating wall securing element 450.

The primary sealing wall 410 is disposed on the primary heat insulating wall 420 to seal the storage tank containing LNG in a liquid-tight manner while contacting the LNG.

The secondary sealing wall 430 is interposed between the primary heat insulating wall 420 and the secondary heat insulating wall 440 and serves to seal the storage tank in a liquid-tight manner when the primary sealing wall 410 leaks.

A plurality of corrugated portions is formed in both the primary sealing wall 410 and the secondary sealing wall 430 to prevent damage due to shrinkage and elongation due to temperature changes. The corrugated portion expands or contracts due to temperature changes caused by loading/unloading of LNG to prevent damage due to thermal deformation applied to the primary sealing wall 410 and the secondary sealing wall 430. As shown in FIG. 5, the primary sealing wall 410 has a greater number of corrugated portions than the secondary sealing wall 430. This is because the primary sealing wall 410 is in direct contact with LNG and thus undergoes more expansion or contraction due to temperature change than the secondary sealing wall 430.

Each of the primary sealing wall 410 and the secondary sealing wall 430 may be formed of stainless steel.

The primary heat insulating wall 420 is disposed under the primary sealing wall 410 to thermally insulate the storage tank, and the secondary heat insulating wall 440 is installed on an inner wall of the LNG storage tank to thermally insulate the storage tank. In other words, the LNG storage tank is provided on the inner wall thereof with the secondary heat insulating wall 440, and the primary heat insulating wall 420 is disposed above the secondary heat insulating wall 440.

Each of the primary heat insulating wall 420 and the secondary heat insulating wall 440 is composed of an upper plate, a lower plate, and an insulator formed between the upper plate and the lower plate. The upper plate and the lower plate may be formed of plywood, and the insulator may be formed of polyurethane foam.

The primary sealing wall 410, which directly contacts LNG, is disposed on the upper plate of the primary heat insulating wall 420. A metal strip 460 is disposed on the upper plate of the primary heat insulating wall 420, and the primary sealing wall 410 is welded to the strip 460.

The secondary sealing wall 430 is disposed on the upper plate of the secondary heat insulating wall 440. A metal strip is disposed on the upper plate of the secondary heat insulating wall 440 and the secondary sealing wall 430 is welded to the strip 460.

The heat insulating wall securing element 450 serves to secure the primary heat insulating wall 420 to the secondary heat insulating wall 440. Specifically, the heat insulating wall securing element secures the primary heat insulating wall 420 to the secondary heat insulating wall 440 such that the primary heat insulating wall can slide in a horizontal direction.

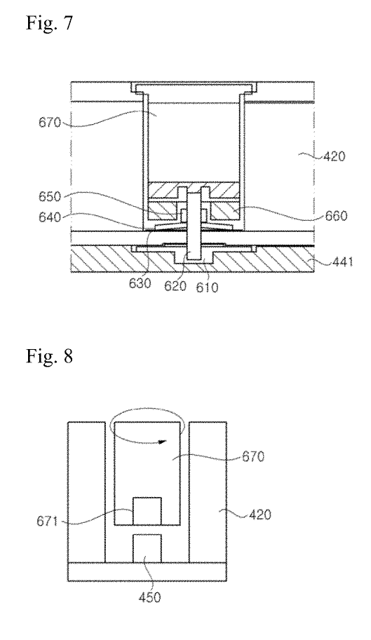

FIG. 7 is a view illustrating a structure of a heat insulating wall securing element for an LNG storage tank according to an embodiment of the present invention, and FIG. 8 is a view illustrating a method of installing a plug of the heat insulating wall securing element for the LNG storage tank according to the embodiment of the present invention.

Referring to FIG. 7, the heat insulating wall securing element 450 includes a stud bolt 620, a special washer 630, a spring washer 640, a nut 650, and a spacer 660.

A metal strip 610 is disposed on the upper plate 441 of the secondary heat insulating wall 440 and the stud bolt 620 is secured to the strip. Since threads are formed on the strip 610 and on a lower end portion of the stud bolt 620, the stud bolt 620 is secured to the strip 610 by engaging the thread of the strip 610 with the thread of the stud bolt 620, followed by tightening the bolt.

A through-hole is formed through each of the primary heat insulating wall 420 and the secondary sealing wall 430 at a portion where the heat insulating wall securing element 450 will be installed. When the primary heat insulating wall 420 and the secondary sealing wall 430 are installed on the secondary heat insulating wall 440, the stud bolt 620 is inserted into the through-hole of each of the primary heat insulating wall 420 and the secondary sealing wall 430. Then, after mounting the special washer 630 and the spring washer 640, the nut 650 is fastened to the stud bolt 620 to secure the primary heat insulating wall 420 to the secondary heat insulating wall 440.

The special washer 630 serves to prevent the lower plate of the primary heat insulating wall 420 from being separated from the heat insulating wall securing element 450 even when the lower plate contracts. The special washer 630 has a larger diameter than the nut 650 to secure a large area where the lower plate of the primary heat insulating wall 420 can slide.

The spring washer 640 can prevent the nut 650 from loosening when the lower plate of the primary heat insulating wall 420 vertically contracts.

After the nut 650 is fastened to the stud bolt 620, the spacer 660 may be mounted. The spacer 660 has a donut shape surrounding a side surface of the nut and may be formed of plywood. The spacer 650 serves to distribute the load of LNG to protect the bolt and the nut.

The heat insulating wall securing element 450 according to the embodiment of the present invention is configured to allow the lower plate of the primary heat insulating wall 420 to slide between the secondary sealing wall 430 and the special washer 630, such that the primary heat insulating wall 420 can slide in the horizontal direction when undergoing thermal contraction, thereby minimizing thermal stress.

A plug is provided to plug a hole required for mounting the heat insulating wall securing element 450.

As described above, the hole for mounting the heat insulating wall securing element 450 is formed through the primary heat insulating wall. If the hole is left after installation of the heat insulating wall securing element 450 is completed, a cold spot can occur, causing a structural problem in the insulation system of the storage tank and increasing a boil off rate (BOR). In order to solve such a problem, the hole is plugged with the plug 670. After mounting the spacer 660, the plug 670 is securely inserted into the hole. As shown in FIG. 7, a thread 671 is formed on a bottom surface of the plug 670 to be coupled to the stud bolt 620, such that the plug 670 can be bolted to an upper portion of the heat insulating wall securing element 450.

The plug 670 has a cylindrical shape and may include an upper sheet, an insulator, a lower sheet, and a lower cap. The upper sheet and the lower sheet may be formed of plywood and the insulator may be formed of polyurethane foam.

The lower cap is placed under the lower sheet and is composed of a cap portion and a flange radially extending from a lower end of the cap portion. The lower sheet is formed at the center thereof with a hole into which the cap portion of the lower cap is inserted. The cap portion is formed therein with a thread, which will be fastened to the upper portion of the stud bolt 620, such that the plug 670 can be coupled to the heat insulating wall securing device 450.

The plug mounting method according to the embodiment of the present embodiment is advantageous in that the method can facilitate installation of the plug, reduce the working time, and provide a strong and stable holding force, as compared with a method of installing the plug 670 using adhesives.

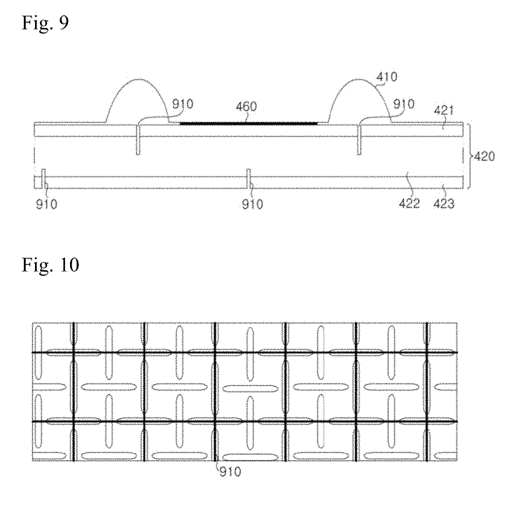

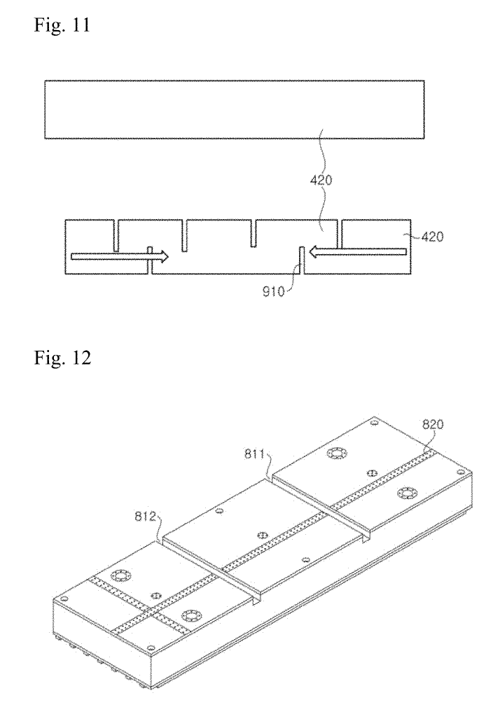

Next, slits of a primary heat insulating wall for an LNG storage tank according to another embodiment of the present invention will be described with reference to FIGS. 9 to 11. FIG. 9 is a view of a primary heat insulating wall of the LNG storage tank according to the embodiment of the present invention, FIG. 10 is a view showing the location where a primary sealing wall of the LNG storage tank according to the embodiment of the present invention meets upper slits of the primary heat insulating wall of the LNG storage tank, and FIG. 11 is a view showing thermal contraction-induced behavior of the primary heat insulating wall of the LNG storage tank according to the embodiment of the present invention.

Referring to FIG. 9, the primary heat insulating wall of the LNG storage tank according to the embodiment of the invention is formed with upper and lower slits 910. A plurality of upper slits of the primary heat insulating wall 420 is formed in an upper plate 421 at constant intervals, and a plurality of lower slits of the primary heat insulating wall 420 is formed in a lower plate 423 at constant intervals.

The upper slits of the primary heat insulating wall 420 may extend from the uppermost portion of the upper plate 421 to an upper portion of an insulator 422, and the lower slits of the primary heat insulating wall 420 may extend from the lowermost portion of the lower plate 421 to a lower portion of the insulator 422. In addition, the upper slits may be formed at the points where the primary heat insulating wall 420 meets corrugated portions of the primary sealing wall 410.

Referring to FIG. 10, the plurality of upper slits 910 of the primary heat insulating wall 420 may be formed in a grid pattern. In addition, the plurality of lower slits 910 of the primary heat insulating wall 420 may also be formed in a grid pattern.

At the upper side of FIG. 11, there is shown a primary heat insulating wall 420 which is placed at room temperature and is not deformed, and, at the lower side of FIG. 9, there is shown a primary heat insulating wall 420 which is under cryogenic conditions during carriage of LNG. Referring to FIG. 11, it can be seen that, by forming a plurality of slits in the upper and lower portions of the primary heat insulating wall 420, the primary heat insulating wall 420 is prevented from being bent upward and contract in the transverse and longitudinal directions without undergoing warpage. As such, the upper and lower slits 910 of the primary heat insulating wall 420 can reduce stress of the primary heat insulating wall 420 upon thermal contraction of the primary heat insulating wall 420. As a result, stress generated in the heat insulating wall securing element 450 is lowered, thereby providing structural stability to the storage tank.

Next, arrangement of corrugated portions of a secondary sealing wall of an LNG storage tank according to a further embodiment of the present invention will be described with reference to FIGS. 5 to 6 and 12 to 13.

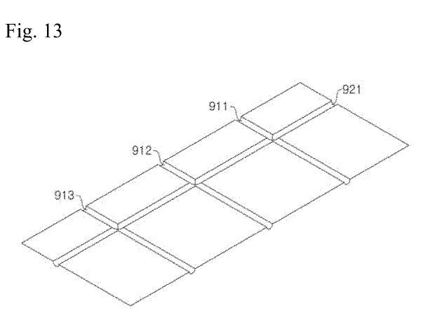

FIG. 12 is a view of a secondary heat insulating wall panel according to an embodiment of the present invention and FIG. 13 is a view of a secondary sealing wall unit according to an embodiment of the present invention.

Referring to FIGS. 5 and 6, corrugated portions 911, 912, 913 of the secondary sealing wall 430 are disposed in a gap between the plural secondary heat insulating wall panels or in a groove of the secondary heat insulating wall panel.

Referring to FIG. 12, the secondary heat insulating wall panel is formed at an upper portion thereof with grooves 811, 812. Here, the grooves may extend from the uppermost portion of an upper plate of the secondary heat insulating wall to a portion of the insulator.

Although two grooves are shown in FIG. 12, it should be understood that the present invention is not limited thereto and the number of grooves may be changed in various way.

The secondary sealing wall 430 may be composed of a plurality of secondary sealing wall units. FIG. 13 shows a secondary sealing wall unit constituting the secondary sealing wall. Referring to FIG. 13, the secondary sealing wall unit has corrugated portions formed downward. Although one longitudinal corrugated portion 921 and three transverse corrugated portions 911, 912, 913 are shown in FIG. 13, it should be understood that the present invention is not limited thereto, and the number of corrugated portions may be changed in various ways.

Referring to FIG. 6, when the secondary sealing wall unit as shown in FIG. 13 is disposed on the secondary heat insulating wall 440, the first transverse corrugated portion 911 and the longitudinal corrugated portion 921 may be disposed in gaps between secondary heat insulating wall panels, the second transverse corrugated portion 912 may be disposed in the first groove 811, and the third transverse corrugated portion 913 may be disposed in the second groove 812.

In addition, the secondary heat insulating wall panel is provided on an upper portion thereof with a metal strip 820 for welding the secondary sealing wall such that an edge of the secondary sealing wall unit is welded to the strip 820 in order to secure the secondary sealing wall to the secondary heat insulating wall.

Although some embodiments have been described herein, it should be understood by those skilled in the art that these embodiments are given by way of illustration only, and that various modifications, variations and alterations can be made without departing from the spirit and scope of the invention. Therefore, the embodiments disclosed herein should not be construed as limiting the technical scope of the present invention, but should be construed as illustrating the idea of the present invention. The scope of the present invention should be interpreted according to the appended claims and equivalents thereof.

### LIST OF REFERENCE NUMERALS

410: Primary sealing wall

420: Primary heat insulating wall

430: Secondary sealing wall

440: Secondary heat insulating wall

450: Heat insulating wall securing element

460: Strip

620: Stud bolt

630: Special washer

640: Spring washer

650: Nut

660: Spacer

670: Plug

811, 812: Groove

910: Slit

911, 912, 913, 921: Corrugated portion

1-8. (canceled)

9. A liquefied natural gas storage tank comprising:
a primary sealing wall contacting liquefied natural gas stored in the storage tank and sealing the storage tank in a liquid-tight manner;
a primary heat insulating wall disposed under the primary sealing wall and thermally insulating the storage tank;
a secondary heat insulating wall disposed on an inner wall of the storage tank and thermally insulating the storage tank; and
a secondary sealing wall interposed between the primary heat insulating wall and the secondary heat insulating wall and sealing the storage tank in a liquid-tight manner when the primary sealing wall leaks,
wherein the secondary heat insulating wall comprises a plurality of secondary heat insulating wall panels, each of the secondary heat insulating wall panels having a groove formed at an upper portion thereof, the secondary sealing wall is formed with a corrugated portion, and the secondary sealing wall is placed on the secondary heat insulating wall such that the corrugated portion is located in a gap between the plurality of secondary heat insulating wall panels and in the groove.

10. The liquefied natural gas storage tank according to claim 9, further comprising:
a heat insulating wall securing element securing the primary heat insulating wall to the secondary heat insulating wall such that the primary heat insulating wall can slide in a horizontal direction.

11. The liquefied natural gas storage tank according to claim 10, wherein the heat insulating wall securing element, comprises a stud bolt secured to the secondary heat insulating wall and a nut fastened to the stud bolt, and
wherein the primary heat insulating wall is formed with a through-hole,
the stud bolt being inserted into the through-hole and fastened to the nut such that the primary heat insulating wall is secured to the secondary heat insulating wall.

12-15. (canceled)
